(19) United States
(12) Patent Application Publication
(10) Pub. No.: US 2008/0086355 A1
(43) Pub. Date: Apr. 10, 2008

(54) System and method for forwarding and delegating asynchronous traking and quantifying of events

(76) Inventors: Raymond Bradley, Walnut Creek, CA (US); Jeremy Evans, Lafayette, CA (US); Dmytro Bazulin, Prevost (CA); Michael Cahill, San Rafael, CA (US); Christopher Povio, Tiburon, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/545,175

(22) Filed: Oct. 5, 2006

(51) Int. Cl. G06F 15/02

(52) U.S. Cl. 705/9

(57) ABSTRACT

An apparatus and a method of cost recovery in a computerized system performs the steps of initiating a job task at a first computer, extracting job statistics relating to the initiated job task from a server, storing the job statistics in a database queue, asynchronously communicating the stored job statistics from the database queue to a first computer of a first user to whom the job task is not to be allocated, controlling communication of the job statistics from the first computer of the first user dependent on a relationship of allocation of a second user to the job task, and processing the forwarded job statistics in the computerized system by the second user to create a bill or report. In this manner, computerized cost allocations and processing of job statistics are made by cooperative relationships and actions between multiple users.

### BACKGROUND OF THE INVENTION

1. Field of the Invention

The invention relates to the field of the methods and apparatus for computerized cost recovery of information processing events.

2. Description of the Prior Art

The applicants have previously devised a system and method for asynchronous tracking and quantifying of printing events, which was filed as U.S. patent application Ser. No. 10/052,167, filed on Jan. 17, 2002, and published as US Patent Publication 2002/0113995 on Aug. 22, 2002, which is incorporated herein by reference. This is a two-phase asynchronous print tracking system and method is described. The separation of detection of print activity and billing of print activity is accomplished by means of a quota-based message queue. Print jobs sent by a user are allowed to print without interruption until a quota number of print jobs for which no billing information has been entered are reached. When the quota is exceeded, the user may not continue until appropriate billing information is entered.

As described in the previous patent application, an expense is tracked at the point on the network where it occurs, such as a print server, copy machine, fax machine, etc. Using an asynchronous transport mechanism, data about the expense item is routed to the desktop of the user responsible. Based on rules established in the software, the user is then prompted to allocate the expense to an accounting code, such as a project, client, department, etc.

### BRIEF SUMMARY OF THE INVENTION

The illustrated embodiments of the invention are directed to a method of cost recovery in a computerized system comprising the steps of initiating a job task at a first computer, extracting job statistics relating to the initiated job task from a server, storing the job statistics in a database queue, asynchronously communicating the stored job statistics from the database queue to a first computer of a first user to whom the job task is not to be allocated, controlling communication of the job statistics from the first computer of the first user dependent on a relationship of allocation of a second user to the job task, and processing the forwarded job statistics in the computerized system by the second user to create a bill or report.

In one embodiment the step of controlling communication of the job statistics from the first computer of the first user dependent on a relationship of allocation of a second user to the job task comprises the step of selectively forwarding the communicated job statistics from the first computer of the first user to a second computer of a second user to whom the job task is to be allocated.

In another embodiment the step of controlling communication of the job statistics from the first computer of the first user dependent on a relationship of allocation of a second user to the job task comprises the step of selectively delegating the job task by the first user at the first computer to a second user to whom the job task is to be allocated.

In general a plurality of users are communicated to the computerized system. The step of controlling communication of the job statistics from the first computer of the first user dependent on a relationship of allocation of a second user to the job task further comprises the step of selectively permitting the first user to control communication of the job statistics only to a predetermined subset of the plurality of users for security control.

In yet another embodiment the step of controlling communication of the job statistics from the first computer of the first user dependent on a relationship of allocation of a second user to the job task further comprises selectively permitting the first user to selectively forwarding the communicated job statistics from the first computer of the first user to only to a predetermined subset of the plurality of users for security control.

In still another embodiment the step of controlling communication of the job statistics from the first computer of the first user dependent on a relationship of allocation of a second user to the job task further comprises selectively permitting the first user to selectively delegating the job task by the first user at the first computer to only to a predetermined subset of the plurality of users for security control.

In still another embodiment the step of initiating the job task at the first computer comprises the step of initiating the job task at a terminal communicated to a walk-up device.

The method may further comprise the step of performing the job task after extracting job statistics relating to the initiated job task from a server.

The step of processing the forwarded job statistics in the computerized system by the second user to create a bill or report comprises the steps of allocating job statistics related to the job task to the second user, generating corresponding billing information, storing the billing information in an activity database, and generating a report and/or billing including at least part of the billing information.

The step of extracting job statistics relating to the initiated job task from a server comprises the step of extracting information characterizing the task and its cost, where the task includes processing, handling, communication, transmission, reception, usage, storage, formatting, inputting, scanning or retrieval of information.

The illustrated embodiments further comprise an apparatus or improvements to a computerized system for performing any one of the above disclosed steps in any combination. The means for performing the various steps disclosed above include software or firmware controlled computers, processors, digital signal processors, digital and/or analog logic circuits, programmed arrays, memories and combinations of the same organized in communicated networks.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a block diagram showing the work flow of the prior art methodology.

FIG. 2 is a display screen of a forwarding interface of the illustrated embodiment.

FIG. 3 is a diagram illustrating the work flow of the forwarding method.

FIG. 4 is a display screen of a delegation interface of the illustrated embodiment.

FIG. 5 is a diagram illustrating the work flow of the delegation method.

FIG. 6 is a display screen of a security interface of the illustrated embodiment in which delegation and forwarding permissions are assigned to users.

FIG. 7 is a diagram illustrating the work flow of the forwarding and delegation methods of the illustrated embodiment, when applied to cost recovery from the use of a walk-up device.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

The cost recovery method of the illustrated embodiment captures office expenses, such as print, copy, scan and fax activity. However, it must be understood that any cost-creating event can be captured and processed by the present invention and the invention is not limited to office expenses. For example, costs and job statistics related to any kind of office tasks such as printing, copying, faxing, telephoning, teleconferencing, videoconferencing, scanning or archiving or other communication, transmission, reception, usage, storage or retrieval of information can also be captured and processed. The features disclosed in the illustrated embodiment extend the asynchronous routing concept first introduced in the previous patent application referenced above.

These new features, which are identified by the keywords, “forwarding” and “delegation”, afford users new routing options designed for large or complex office environments. Specifically, the new features are intended for scenarios in which one person performs work on behalf of another. These new features are unique among cost recovery software providers.

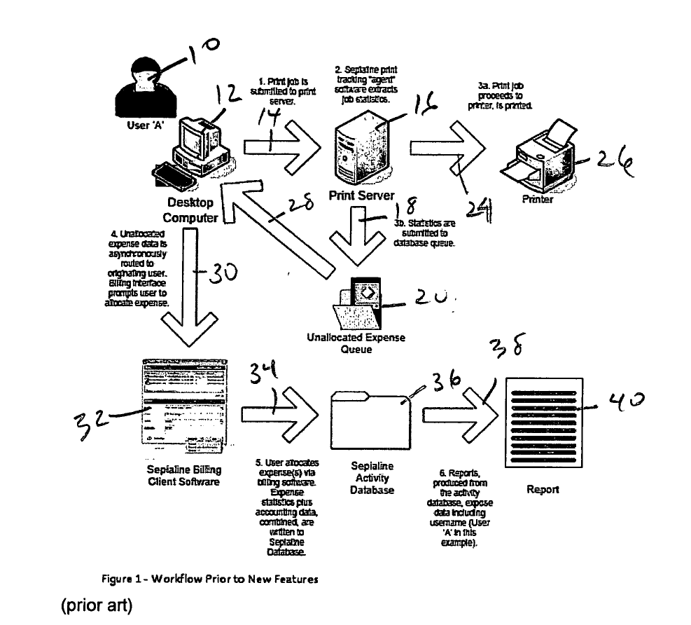

For clarity the illustrated embodiment is directed only to printing events, but it must be borne in mind that the disclosure is directed to any kind of information or communication event now known or later devised. The prior art method operates by detecting print jobs or the target event at the print server or target domain respectively. As shown in the block diagram of FIG. 1 user 10 initiates a print job on computer 12 which is detected at step 14 when it is submitted to print server 16. Data or job statistics about each print job is extracted by print server 16 which is immediately forwarded at step 18 to an unallocated expense queue 20 within a database. The print job proceeds at step 24 to printer 26 and is printed. The job statistics are asynchronously routed at step 28 to the originating user 10 at computer 12 for allocation of the costs. A billing interface 32 prompts user 10 to allocate expenses at step 30. The user 10 allocates expense(s) via billing software. Expense statistics plus accounting data, combined, are written to database 36 at step 34. Reports, produced from the activity database 36, expose or report the cost data including the username of user 10 in a report 40.

The new features described in this disclosure cover expense types in addition to printing. The new forwarding and delegation features are intended for the case where one user 10a is working on behalf of another user 10b. An example is the case where a legal assistant (User 10a) is printing a disclosure for an attorney (User 10b). As outlined in the prior method of FIG. 1, the result of this action would be an expense data record with User 10a as the recorded user. In the case where User 10a is performing work for User 10b, the expense data should contain User 10b as the recorded user, in spite of the fact that User 10a actually performed the work. Showing the responsible user 10b instead of the executing user 10a offers a more accurate analysis of expenses in an office.

There are several possible workflows arising from this type of use. First, the originating user 10a does not possess the information necessary to accurately allocate the expense activity. The originating user 10a, therefore, forwards the unbilled expense item to the responsible user 10b. Alternatively, the originating user 10a does posses the information necessary to accurately allocate the expense activity. The originating user 10a, therefore, records the expense item on behalf of (“delegates to”) the responsible user 10b.

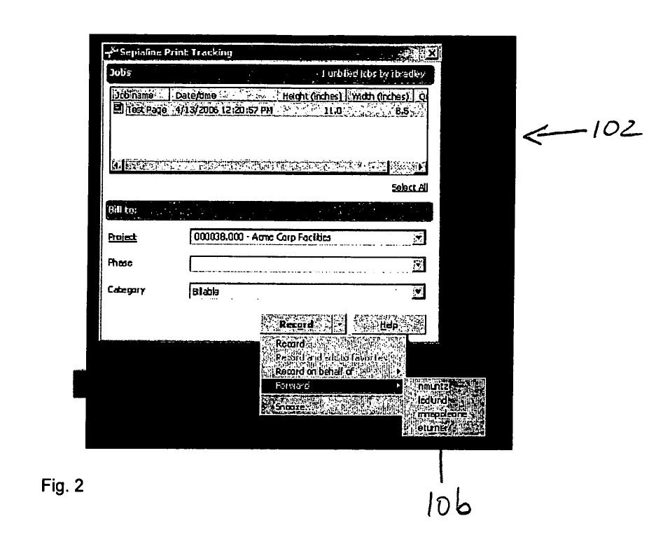

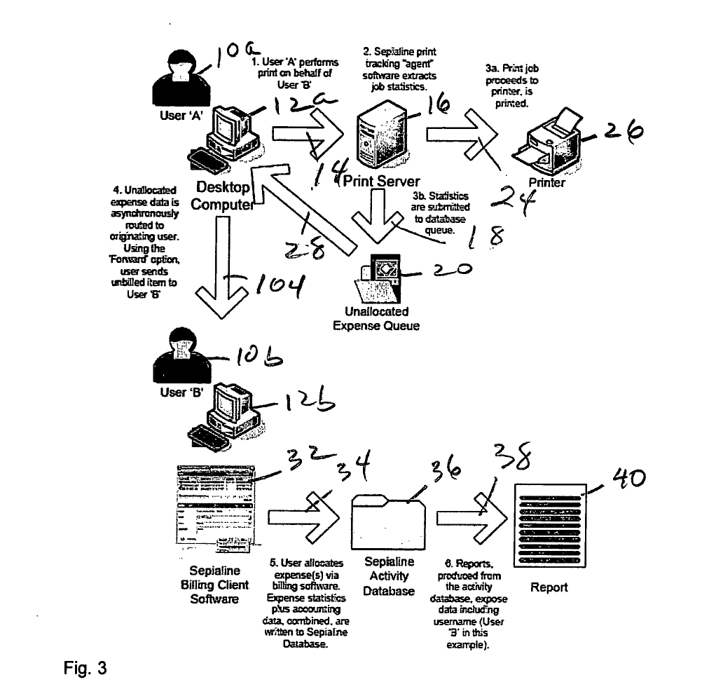

The forwarding workflow is similar to the forwarding feature found in e-mail systems. Via the software billing interface 100, user 10a is prompted to allocate an expense item after performing an action such as printing. Rather than selecting a billing code and using the normal record option, the user 10a will select a forward flyout menu 102 from the software billing interface 100, the display screen for which is depicted in FIG. 2. The originating user 10a selects the responsible user 10b from the flyout menu 102. Once forwarded, the responsible user 10b is prompted as if he had performed the action himself as illustrated by the work flow diagram of FIG. 3.

FIG. 3 illustrates the forwarding work flow. User 10a performs a print job on behalf of user 10b and it is sent to the print server 16 at step 14. The print tracking “agent” software extracts job statistics at step 18 which are submitted to database queue 20. The print job proceeds to printer 26 at step 24 and is printed. The unallocated expense data is asynchronously routed to computer 12a and the originating user 10a at step 28. Using the forward option of the illustrated embodiment, user 10a sends the unbilled item to computer 12b and user 10b at step 104. User 10b allocates expense(s) via billing software 32. Expense statistics plus accounting data, combined, are written at step 34 to database 36. Reports, produced from the activity database 36, expose or report data including the username of user 10b.

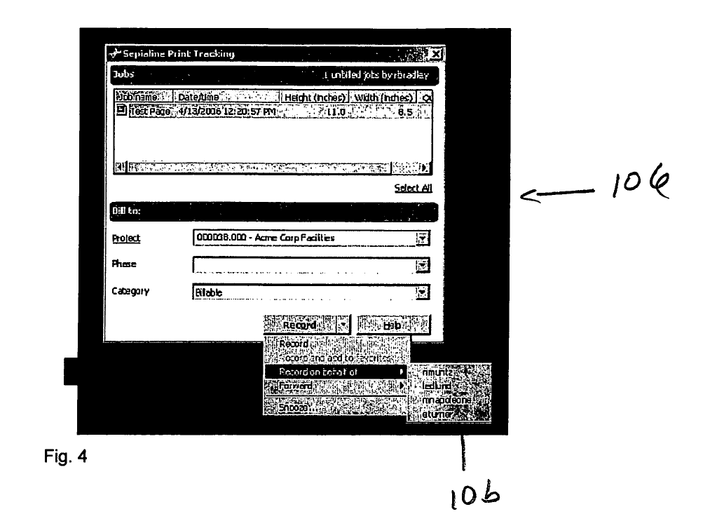

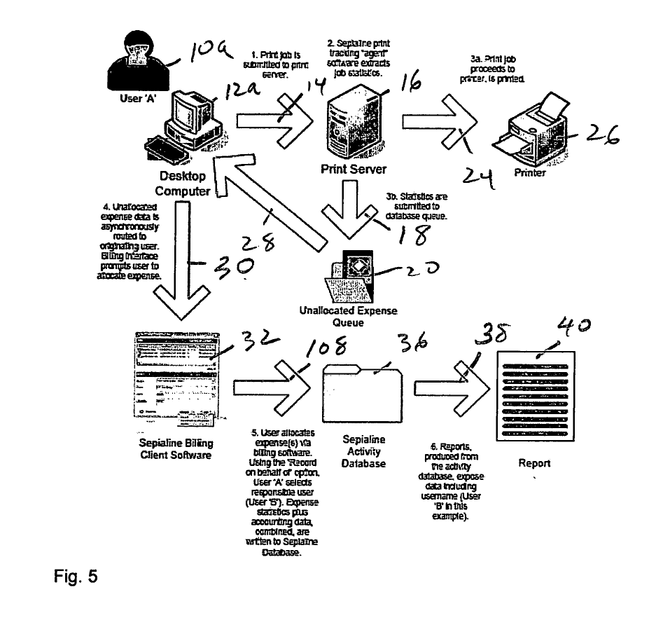

Unlike forwarding, the delegation workflow in FIG. 5 only involves one user 10a, namely the originating user 10a. When prompted to allocate an expense item, rather than using the normal record operation, the user 10a selects the delegation user menu 106 of FIG. 4, and then selects the responsible user 10b. The remainder of the allocation process, e.g. selecting billing codes, statuses, supplying comments, etc., is performed in the same manner as in the incorporated previous patent application referenced above.

Under the delegation workflow of FIG. 5, the recorded data possesses the username of the responsible user 10b, not the originating user 10a. From a data reporting perspective, it is as if User 10b had performed the expense activity himself, even though it was, in fact, User 10a who performed the activity. Consider the delegation work flow as diagrammatically set out in FIG. 5. The print job is submitted by user 10a to print server 16 at step 14. The print tracking “agent” software extracts job statistics which are submitted to database queue 20 at step 18. The print job proceeds to printer 26 at step 24 and is printed. The unallocated expense data is asynchronously routed to originating user 10a at computer 12a at step 28. The billing interface 32 prompts user 10a to allocate the expense at step 30. User 10a allocates expense(s) via billing software 32. Using the delegation user interface 106 of FIG. 4, User 10a selects responsible user 10b at step 108. Expense statistics plus accounting data, combined, are written to the database 36. Reports 40, produced from the activity database 36, expose or report the data at step 38 including username of user 10b.

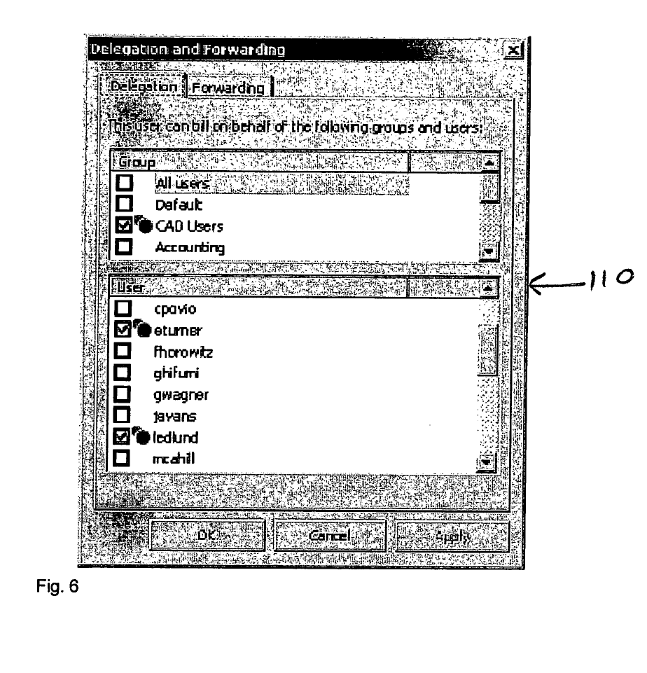

In order to prevent users from abusing or misusing the forwarding and delegation features, the method of the illustrated embodiment incorporates a security component that allows or disallows users from forwarding or delegating to other users as depicted in the screen of the permissions interface 110 of FIG. 6. Permissions can be applied to specific users, or to groups of users by an administrator.

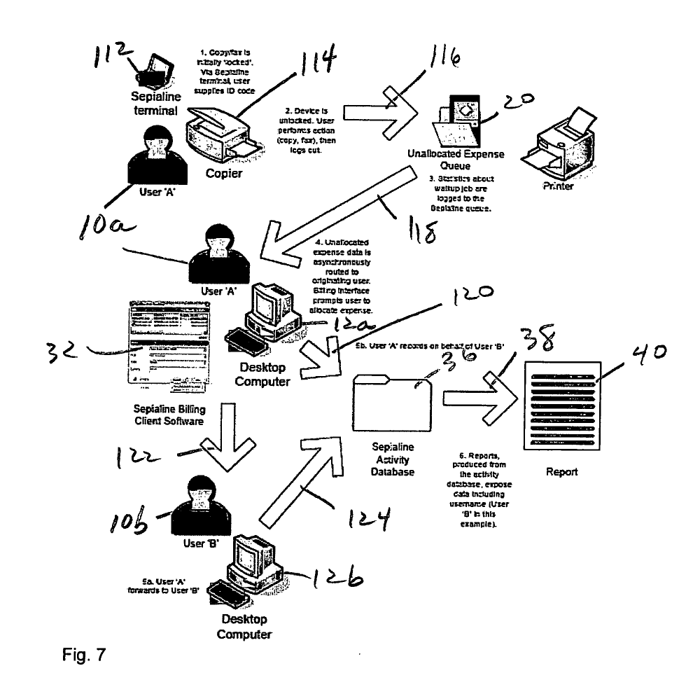

In addition to printing, the methodology of the illustrated embodiments and its hardware captures office equipment such as walkup copiers and fax machines. The forwarding and delegation features described in this disclosure apply to these nonprinting expense types as well. The workflow for walkup devices 114 is diagrammatically depicted in FIG. 7 and involves a terminal 112 located near the device 114. Upon logging in and performing expense activities, unbilled expense data is routed back to the user's desktop 12. From that point, the user 10 may employ the forwarding and delegation features as described above.

Consider now the walkup scenario of FIG. 7 in more detail. Initially the copy/fax 114 is initially locked. Via terminal 112, user 10a supplies an identification code. Device 114 is then unlocked. User 10a performs action (copy, fax) at step 116, then logs out. Statistics relating to the walkup job are logged to the queue 20. Unallocated expense data is asynchronously routed to originating computer 12a of user 10a at step 118. Billing interface 32 prompts user 10a to allocate the expense. User 10a then records the expense on behalf of user 10b using the delegation process at step 120 or forwards the expense allocation task to computer 12b of user 10b at step 122. User 10b then allocates the expenses via billing software and sends the statistics and accounting data to the activity database 36 at step 124. Reports 40, produced from the activity database 36, expose or report the data including the username of user 10b.

In summary, the workflow features disclosed above in which two or more users are cooperatively engaged in cost recovery are unique among cost recovery systems and methods. The ability to allocate expenses to different users is particularly useful in complex team-based environments where users perform actions for other users. Moreover, the expense routing capability used in conjunction with walkup devices is also unique. In this manner, computerized cost allocations and processing of job statistics are made by cooperative relationships and actions between multiple users.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method of cost recovery in a computerized system comprising:
initiating a job task at a first computer;
extracting job statistics relating to the initiated job task from a server;
storing the job statistics in a database queue;
asynchronously communicating the stored job statistics from the database queue to a first computer of a first user to whom the job task is not to be allocated;
controlling communication of the job statistics from the first computer of the first user dependent on a relationship of allocation of a second user to the job task; and
processing the forwarded job statistics in the computerized system by the second user to create a bill or report.

2. The method of claim 1 where controlling communication of the job statistics from the first computer of the first user dependent on a relationship of allocation of a second user to the job task comprises selectively forwarding the communicated job statistics from the first computer of the first user to a second computer of a second user to whom the job task is to be allocated.

3. The method of claim 1 where controlling communication of the job statistics from the first computer of the first user dependent on a relationship of allocation of a second user to the job task comprises selectively delegating the job task by the first user at the first computer to a second user to whom the job task is to be allocated.

4. The method of claim 1 where a plurality of users are communicated to the computerized system and where controlling communication of the job statistics from the first computer of the first user dependent on a relationship of allocation of a second user to the job task further comprises selectively permitting the first user to control communication of the job statistics only to a predetermined subset of the plurality of users for security control.

5. The method of claim 1 where initiating the job task at the first computer comprises initiating the job task at a terminal communicated to a walk-up device.

6. The method of claim 1 further comprising performing the job task after extracting job statistics relating to the initiated job task from a server.

7. The method of claim 1 where processing the forwarded job statistics in the computerized system by the second user to create a bill or report comprises allocating job statistics related to the job task to the second user, generating corresponding billing information, storing the billing information in an activity database, and generating a report and/or billing including at least part of the billing information.

8. The method of claim 2 where a plurality of users are communicated to the computerized system and where controlling communication of the job statistics from the first computer of the first user dependent on a relationship of allocation of a second user to the job task further comprises selectively permitting the first user to selectively forwarding the communicated job statistics from the first computer of the first user to only to a predetermined subset of the plurality of users for security control.

9. The method of claim 3 where a plurality of users are communicated to the computerized system and where controlling communication of the job statistics from the first computer of the first user dependent on a relationship of allocation of a second user to the job task further comprises selectively permitting the first user to selectively delegating the job task by the first user at the first computer to only to a predetermined subset of the plurality of users for security control.

10. The method of claim 1 where extracting job statistics relating to the initiated job task from a server comprises extracting information characterizing the task and its cost, where the task includes processing, handling, communication, transmission, reception, usage, storage, formatting, inputting, scanning or retrieval of information.

11. An apparatus of cost recovery in a computerized system comprising:
means for initiating a job task at a first computer;
means for extracting job statistics relating to the initiated job task from a server;
means for storing the job statistics in a database queue;
means for asynchronously communicating the stored job statistics from the database queue to a first computer of a first user to whom the job task is not to be allocated;
means for controlling communication of the job statistics from the first computer of the first user dependent on a relationship of allocation of a second user to the job task; and
means for processing the forwarded job statistics in the computerized system by the second user to create a bill or report.

12. The apparatus of claim 11 where the means for controlling communication of the job statistics from the first computer of the first user dependent on a relationship of allocation of a second user to the job task comprises means for selectively forwarding the communicated job statistics from the first computer of the first user to a second computer of a second user to whom the job task is to be allocated.

13. The apparatus of claim 11 where the means for controlling communication of the job statistics from the first computer of the first user dependent on a relationship of allocation of a second user to the job task comprises means for selectively delegating the job task by the first user at the first computer to a second user to whom the job task is to be allocated.

14. The apparatus of claim 11 where a plurality of users are communicated to the computerized system and where the means for controlling communication of the job statistics from the first computer of the first user dependent on a relationship of allocation of a second user to the job task further comprises means for selectively permitting the first user to control communication of the job statistics only to a predetermined subset of the plurality of users for security control.

15. The apparatus of claim 11 where the means for initiating the job task at the first computer comprises means for initiating the job task at a terminal communicated to a walk-up device.

16. The apparatus of claim 11 further means for comprising performing the job task after extracting job statistics relating to the initiated job task from a server.

17. The apparatus of claim 11 where the means for processing the forwarded job statistics in the computerized system by the second user to create a bill or report comprises means for allocating job statistics related to the job task to the second user, means for generating corresponding billing information, means for storing the billing information in an activity database, and means for generating a report and/or billing including at least part of the billing information.

18. The apparatus of claim 12 where a plurality of users are communicated to the computerized system and where the means for controlling communication of the job statistics from the first computer of the first user dependent on a relationship of allocation of a second user to the job task further comprises means for selectively permitting the first user to selectively forwarding the communicated job statistics from the first computer of the first user to only to a predetermined subset of the plurality of users for security control.

19. The apparatus of claim 13 where a plurality of users are communicated to the computerized system and where the means for controlling communication of the job statistics from the first computer of the first user dependent on a relationship of allocation of a second user to the job task further comprises means for selectively permitting the first user to selectively delegating the job task by the first user at the first computer to only to a predetermined subset of the plurality of users for security control.

20. The apparatus of claim means for 1 where the means for extracting job statistics relating to the initiated job task from a server comprises means for extracting information characterizing the task and its cost, where the task includes processing, handling, communication, transmission, reception, usage, storage, formatting, inputting, scanning or retrieval of information.
